(19) United States
(12) Patent Application Publication
(10) Pub. No.: US 2011/0056826 A1
(43) Pub. Date: Mar. 10, 2011

(54) ALUMINUM ELECTROLYTIC CELL WITH NEW TYPE OF CATHODE STRUCTURE FOR SHORTENING VERTICAL FLUCTUATIONS AND HORIZONTAL FLUCTUATIONS

(76) Inventor: Naixiang Feng, Liaoning (CN)

(21) Appl. No.: 12/991,870

(22) PCT Filed: Apr. 28, 2009
(86) PCT No.: PCT/CN2009/000457

§ 371 Date: Nov. 9, 2010

(30) Foreign Application Priority Data
Oct. 10, 2008 (CN) 200810228017.7

(51) Int. Cl. C25B 9/00; B28B 1/08

(52) U.S. Cl. 204/242; 264/105

(57) ABSTRACT

An aluminum electrolytic cell with a new type of cathode structure for shortening vertical fluctuations and horizontal fluctuations includes an electrolytic cell shell, cell lining, refractory material, cathode carbon blocks, lined carbon bricks, carbon ramming paste, refractory concrete and cathode steel bars. More than one convex structure protrudes from the top surface of the cathode carbon blocks and integrates with the cathode carbon blocks. The convex structure are arrayed to be parallel or vertical with the axis of the cathode carbon blocks or to be mixed with the above two.

### BACKGROUND OF THE INVENTION

1. Field of the Invention

The present invention relates to a technical field of aluminum electrolysis, and more particularly to an aluminum electrolytic cell with a new type of cathode structure for shortening vertical fluctuations and horizontal fluctuations.

2. The Prior Arts

At present, the industrial pure aluminum is manufactured through the electrolysis in molten cryolite-alumina system. The specially used equipment is an electrolytic cell having a cell lining containing carbon material. The materials installed between a steel-made cell shell and the carbon lining are refractory materials and heat insulating bricks. The carbon lining of electrolytic cell is generally composed through laying carbon bricks (or blocks). The carbon brick (or block) is anthracite coal or graphite material which has better corrosion resistances for sodium and electrolyte, or is a mixture of the above two. Connecting locations of the mentioned material or components are tamped with carbon paste made of the mentioned carbon material. Steel bars are installed at the bottoms of carbon blocks provided at the bottom of the electrolytic cell and the steel bars protrude to the exterior of the cell shell. The steel bars are often named as the cathode steel bars of electrolytic cell. A carbon anode made of petroleum coke is hanged above the electrolytic cell, and a metal-made anode rod is installed on top of the anode of electrolytic cell. The electric current can be introduced through the anode rod. The molten cryolite and molten metallic aluminum with the temperature of 940˜970° C. are provided between the carbon cathode and the carbon anode in electrolytic cell. The aluminum fluid does not dissolve with the molten electrolyte, and the density of aluminum is larger than that of molten electrolyte, so aluminum is under the molten electrolyte and in contact with the carbon cathode. When Direct current (DC) is introduced through the carbon anode in electrolytic cell and is guided out from the carbon cathode, because the molten electrolyte is an ionic conductor, the molten electrolyte containing alumina generates an electrochemical reaction at the two electrodes. The result of this reaction is that oxygen generated through ion containing oxygen discharging electricity at the anode reacts with the carbon at the carbon anode. The electrolytic product in a form of CO₂ is discharged from the surface of the anode. The ion containing aluminum discharges electricity at the cathode, and obtains three electrons at the cathode so as to form metallic aluminum. The cathode reaction is processed at the surface of the metallic aluminum fluid in the electrolytic cell. The distance between the surface of the cathode and the bottom surface of the carbon anode is defined as an anode-cathode distance (ACD) in electrolytic cell. In an industrial aluminum electrolytic cell, the ACD is 4˜5 cm. The ACD is a very important parameter. An overly high or an overly low ACD would affect the aluminum electrolytic production, the reason is: an overly low ACD would increase the reaction between the metallic aluminum dissolved from the cathode surface into the molten electrolyte, and the anode gas; the current efficiency (CE) is thereof lowered. An overly high ACD would increase the cell voltage, and the DC power consumption for the aluminum production is therefore increased.

For the aluminum electrolytic production, the highest current efficiency and the lowest power consumption of electrolytic cell are desired. The DC power consumption can be obtained by the following formula:

W(KWH/per ton of aluminum)=2980×Va/CE (1)

Wherein Va is the average cell voltage (V), and CE is the current efficiency (%).

From the mentioned formula, it is known that lowering the power consumption of the aluminum electrolytic production can be achieved by increasing the current efficiency and lowering the average cell voltage.

If the cell voltage decreases 0.1 V, the DC power consumption of electrolytic cell can reduce about 320 (KWH/per ton of aluminum). If the current efficiency of electrolytic cell increases 1%, the DC power consumption can reduce about 150 (KWH/per ton of aluminum). As a result, without any influencing the current efficiency, lowering the cell voltage plays a very important role at the aluminum electrolytic production. If lowering the cell voltage and increasing the current efficiency can be achieved at the same time, then the DC power consumption of aluminum electrolytic production can be greatly affected.

The ACD is a major parameter for determining the value of cell voltage, for a general industrial electrolytic cell, if the ACD reduces 1 mm, the cell voltage can be decreased 35 mV. From the mention formula (1), it is known that in a stat of not reducing the current efficiency, the DC power consumption of aluminum electrolytic production can decrease 100 (KWH/per ton of aluminum). As such, in the state of not reducing the current efficiency of electrolytic cell, lowering the ACD means a lot to the power consumption of aluminum electrolytic production. Generally, the ACD for an industrial aluminum electrolytic cell is 4.5˜5.0 cm, and a cold steel fiber, with a diameter of 15 mm and formed with a hook, is uprightly inserted in the molten electrolyte in electrolytic cell and is vertically hooked on an anode surface for about one minute, then is removed from the electrolytic cell. Through utilizing the boundary surface between aluminum and electrolyte, the distance between the molten aluminum surface and the anode bottom surface can be observed. As such, the distance value obtained through the mentioned method is not the real ACD of electrolytic cell. This is because when the metallic aluminum surface is affected by fluctuations of metallic aluminum surface caused by the electromagnetic field force and the anode gas discharged from the anode in the electrolytic cell. With references of other technical papers, the fluctuation peak of the cathode molten aluminum surface of electrolytic cell is about 2.0 cm. With no molten aluminum fluctuation, the electrolytic production can be processed with the ACD of 2.0˜3.0 cm in the electrolytic cell. The cell voltage can lower 0.7˜1.0 V, so an object of saving 2000˜3000 (KWH/per ton of aluminum) can be achieved.

Based on the mentioned arts and theories, Mr. Nai-Xiang Feng has invented a cathode carbon block having convex wall members along the longitudinal direction of the carbon block, which is the same direction of potline, and an aluminum electrolytic cell having said cathode carbon block structures. Said electrolytic cell has been tested in a large-scale electrolytic cell at the Tian-Tai Aluminum Co., based in Chong Qing, China, the test is to lower the cell voltage from 4.1 V to 3.8 V, and an obvious power saving effect is obtained. But the test results have also found: (1) the cathode structure of the mentioned electrolytic cell has a function of weakening molten aluminum fluctuations from the longitudinal direction of the electrolytic cell, which is perpendicular to direction of the potline, but can not weaken the molten aluminum fluctuations from the transversal direction of the electrolytic cell; and (2) stress differentiations at the connecting locations of the wall protruding from the cathode carbon blocks and the cathode carbon block base are high, thus the protrusions at the connecting locations are fragile and easy to be broken. The broken protrusions may impact the production operation and shorten the cell life.

### SUMMARY OF THE INVENTION

In view of the disadvantages and problems of the mentioned aluminum electrolytic cell with cathode carbon block structures, the present invention provides an aluminum electrolytic cell with a new type of cathode structure for shortening vertical fluctuations and horizontal fluctuations.

The aluminum electrolytic cell with a new type of cathode structure for shortening vertical fluctuations and horizontal fluctuations provided by the present invention includes an electrolytic cell shell, heat insulating materials, bottom refractory bricks and heat insulating bricks, cathode carbon blocks, lined carbon bricks, carbon ramming paste, refractory concrete and cathode steel bars. The top surface of the cathode carbon block is installed with at least one convex structure, each convex structure integrates with the cathode carbon block. The convex structures are arrayed to be parallel or vertical with the axis of the cathode carbon blocks or to be mixed with the above two; wherein the convex structure vertical to the axis of the cathode carbon blocks is defined as a horizontal convex structure, the convex structure parallel to the axis of the cathode carbon blocks is defined as a vertical convex structure.

The material of which the cathode carbon blocks with convex structures are made is the same as the material of which a conventional cathode carbon block of electrolytic cell is made, which is a anthracite coal, artificial graphite debris, or a mixture of anthracite coal and artificial graphite debris, or is a graphitized or semi-graphitized cathode carbon block.

The cross section of the convex structure is in a rectangular or trapezoidal shape or in a mixed shape of rectangle and trapezoid, wherein when the cross section is in a mixed shape of rectangle and trapezoid, the rectangle is above the trapezoid.

The width of the cross section of the convex structures on the cathode carbon block is set with respect to the width of the cathode carbon block base. In a state that the width of the cathode carbon block base is 400 mm, the width of the upper portion of the cross section of the horizontal convex structure is 150˜250 mm, the width of the lower portion thereof is 200˜300 mm. The vertical convex structures are arranged as a single-row or a dual-row arrangement, when being arranged as the single-row arrangement, the width of the upper portion of the cross section of the vertical convex structure is 150˜250 mm, the width of the lower portion thereof is 200˜300 mm; when being arranged as the dual-row arrangement, the width of the upper portion of the cross section of the vertical convex structure is 80˜120 mm, the height of the cross section of the vertical convex structure is 80˜160 mm. If the width of the cathode carbon block base is increased, the size of the cross section of the convex structure is proportionally increased.

When the convex structures on the cathode carbon block are all horizontal convex structures, each horizontal convex structure on two adjacent cathode carbon blocks are staggered with each other. The length of the horizontal convex structure is the same or 40˜60 mm smaller than the width of the cathode carbon block base; the minimum distance between the adjacent horizontal convex structures on a same cathode carbon block is 300·500 mm. The center location of the cathode carbon block, which is closest to the aluminum outlet, is a gap defined by two horizontal convex structures.

When the convex structures on the cathode carbon block are all vertical convex structures, the axis of each vertical convex structure is parallel to the axis of the cathode carbon block base, the length thereof is defined with respect to at least two vertical convex structures aligned on each cathode carbon block. The distance between two ends of the cathode carbon block and the bottoms of the vertical convex structures arranged at the two ends is 30˜50 mm. The vertical convex structures are arranged at two ends with respect to the center of the cathode carbon block base, the gap defined by two vertical convex structures arranged at the middle directly faces the aluminum outlet. The minimum distance between the adjacent vertical convex structures on a same cathode carbon block is 100˜200 mm.

When the convex structures of the cathode carbon block are mixedly arranged, the heights of the horizontal convex structures and the vertical convex structures are the same, the distance between the horizontal convex structure and the vertical convex structure is 30˜100 mm. The convex structure at the center of the cathode carbon block base is the horizontal convex structure. On the cathode carbon block closest to the aluminum outlet, the minimum distance between the horizontal convex structure near the aluminum outlet and the outer lateral surface of the cathode carbon block base is 30˜300 mm. The outer lateral surface of the cathode carbon block base is defined as the lateral surface of the cathode carbon block that faces the cell lining of the aluminum outlet. The mixed arrangements of the horizontal convex structures and the vertical convex structures are categorized to a discontinuous arrangement and a continuous arrangement, when being arranged as the discontinuous arrangement, the distance between the horizontal convex structure and the vertical convex structure is 30˜100 mm; when being arranged as the continuous arrangement, the horizontal convex structure is connected with the vertical convex structure.

When the convex structures of the cathode carbon block are mixedly arranged, the arrangements of the vertical convex structures can be categorized to a single-row arrangement and a dual-row arrangement, when being arranged as the single-row arrangement, the vertical convex structures and the horizontal convex structures on each cathode carbon block are staggered with each other; when being arranged as the dual-row arrangement, every two vertical convex structures aligned as two rows on each cathode carbon block is defined as one set, each set of vertical convex structure is staggered with each horizontal convex structure. The minimum distance between a set of vertical convex structure is 30˜100 mm. The mixed arrangements of the horizontal convex structures and the vertical structures are categorized to a discontinuous arrangement and a continuous arrangement, when being arranged as the discontinuous arrangement, the distance between the horizontal convex structure and the vertical convex structure is 30˜100 mm; when being arranged with as the continuous arrangement, the horizontal convex structure is connected with the vertical convex structure.

The installation of cathode carbon block near the aluminum outlet can ensure a convenient operation of the aluminum outlet.

In the aluminum electrolytic cell with a new type of cathode structure for shortening vertical fluctuations and horizontal fluctuations of the present invention, the manufacturing method of cathode carbon block having convex structures is: the conventional material for manufacturing cathode carbon block is adopted, and a blank material is formed with a means of vibration molding, then is baked; or an elongated blank material is firstly manufactured with the means of vibration molding then is baked, and the required shape is formed through mechanical processing.

The structure of the aluminum electrolytic cell with a new type of cathode structure for shortening vertical fluctuations and horizontal fluctuations of the present invention is: the lateral sides of the interior of the electrolytic cell shell are installed with lined carbon bricks, the cathode at the cell bottom is configured by at least eight cathode carbon blocks having convex structures. A 20˜40 mm gap is formed between the adjacent cathode carbon blocks, and the gap is tamped with carbon ramming paste. Refractory concrete is used for tamping under the lined carbon bricks and above the bottom refractor bricks and heat insulating bricks. The carbon ramming paste is used between the lined carbon bricks and the cathode carbon blocks. The bottoms of the cathode carbon blocks are connected with cathode steel bars, and two ends of each cathode steel bar are protruded outside the electrolytic cell serving as the cathode of the electrolytic cell.

The aluminum electrolytic cell with a new type of cathode structure for shortening vertical fluctuations and horizontal fluctuations of the present invention is installed with cathode carbon blocks having convex structures on the cell lining at the cell bottom. The width of the carbon block base, which is a non-convex structure at the lower portion of the cathode carbon block, is wider than the width of the convex structures installed at the upper portion, and the carbon ramming paste is only used to tamp the space between the non-convex structures of the cathode carbon blocks. So the bottom of the electrolytic cell is formed with rows of convex structures configured by the convex structures of the cathode carbon blocks having protrusions on the top surface. The convex structures are the compositions of the cathode carbon blocks of the electrolytic cell.

The material of which the lined carbon bricks are made is anthracite coal or artificial graphite debris or a mixture of anthracite coal and artificial graphite debris, or silicon carbide.

In the aluminum electrolytic cell with a new type of cathode structure for shortening vertical fluctuations and horizontal fluctuations of the present invention, a groove is formed between two adjacent cathode carbon blocks, the installation method of groove is: two lateral sides of the top surface of the cathode carbon block base are installed with angular concave corners, and the groove is defined between two opposite angular concave corner respectively on two adjacent cathode carbon blocks and the top surface of carbon ramming paste; during production, the groove is filled with sludge made of cryolite and alumina for preventing the cathode steel bars from being molten by the molten aluminum; the depth of the angular concave corner is 20˜50 mm with respect to the top surface of the cathode carbon block base, the width thereof is 20˜50 mm, the length thereof is the same as the length of the cathode carbon block; so the depth of the groove is 20˜50 mm, and the width thereof is 80˜140 mm.

The structure of the aluminum electrolytic cell with a new type of cathode structure for shortening vertical fluctuations and horizontal fluctuations of the present invention is similar to the conventional industrial aluminum electrolytic cell, the obvious difference is that the shape and structure of the cathode carbon blocks at the bottom of the electrolytic cell are different from those in the conventional electrolytic cell. Moreover, the lateral sides and bottom side of the aluminum electrolytic cell with a new type of cathode structure for shortening vertical fluctuations and horizontal fluctuations are quipped with a better design for heat insulation.

The manufacturing method of the aluminum electrolytic cell with a new type of cathode structure for shortening vertical fluctuations and horizontal fluctuations of the present invention is as follows:
1. An aluminum electrolytic cell with a new type of cathode structure for shortening vertical fluctuations and horizontal fluctuations is provided;
2. The aluminum electrolytic cell with a new type of cathode structure for shortening vertical fluctuations and horizontal fluctuations of this invention is processed with a baking operation of baking with flames or firstly baking with flames then baking aluminum fluid, after the baking operation, the electrolytic cell is started-up with a conventional means of electrolytic cell start-up;
3. In the normal production technology management after the electrolytic cell is started, the aluminum level in the electrolytic cell is 10˜50 mm after the aluminum is outputted and calculated from the top surface of convex structure. In the normal production, the ACD of the electrolytic cell is 25˜40 mm, the cell voltage is 3.3˜3.9 V.
4. In the electrolytic process, an alumina electrolyte sludge groove installed above the carbon ramming paste and between the cathode carbon block bases is filled with sludge made of cryolite and alumina, at the electrolysis temperature, the sludge is molten for sealing cracks generated after the carbon ramming paste is sintered. As such, the cathode steel bars are protected from being molten by the molten aluminum and the electrolytic cell is protected from being damaged Beside the abovementioned disclosures, in the normal production, arts adopted in the aluminum electrolytic cell with a new type of cathode structure for shortening vertical fluctuations and horizontal fluctuations of this invention are the same as the arts adopted in conventional aluminum electrolytic cell with cathode structures. The technical working conditions of the arts are as follows. The electrolyte level is 15˜25 cm, the molar ratio of electrolyte is 2.0˜2.8, the concentration of alumina is 1.5˜5%, and the electrolysis temperature is 935˜975° C.

In the state of the mentioned arts, the electrolytic reaction at the cathode of the electrolytic cell is:

Al³⁺(compound)+3e=Al

The aluminum electrolytic cell with a new type of cathode structure for shortening vertical fluctuations and horizontal fluctuations provided by the present invention is able to reduce the flow rate of molten aluminum and shortening the vertical and horizontal fluctuations of the molten aluminum, so the stability of the metallic aluminum is improved, and the aluminum dissolved loss is reduced, the current efficiency is increased and the ACD can be decreased, such that the cell voltage and the power consumption for aluminum electrolytic production are lowered, and the strengths at the connecting locations of the protruded wall members and the bases are enhanced so as to lower the damage and prolong the service life. The installation of convex structures in a trapezoidal shape or a mixed shape of rectangle and trapezoid can ensure the convex structures have sufficient strengths.

### BRIEF DESCRIPTION OF THE DRAWINGS

The present invention will be apparent to those skilled in the art by reading the following detailed description of a preferred embodiment thereof, with reference to the attached drawings, in which:

FIG. 1 is a schematic view of the aluminum electrolytic cell with a new type of cathode structure for shortening vertical fluctuations and horizontal fluctuations of the first embodiment of the present invention;

FIG. 2 is a schematic cross sectional view of FIG. 1 along a B-B plane;

FIG. 3 is a schematic view of the aluminum electrolytic cell with a new type of cathode structure for shortening vertical fluctuations and horizontal fluctuations of the second embodiment of the present invention;

FIG. 4 is a schematic cross sectional view of FIG. 3 along a B-B plane;

FIG. 5 is a schematic view of the aluminum electrolytic cell with a new type of cathode structure for shortening vertical fluctuations and horizontal fluctuations of the third embodiment of the present invention;

FIG. 6 is a schematic cross sectional view of FIG. 5 along a B-B plane;

FIG. 7. is a schematic view of the aluminum electrolytic cell with a new type of cathode structure for shortening vertical fluctuations and horizontal fluctuations of the fourth embodiment of the present invention;

FIG. 8 is a schematic cross sectional view of FIG. 7 along a B-B plane;

FIG. 9 is a schematic view of the aluminum electrolytic cell with a new type of cathode structure for shortening vertical fluctuations and horizontal fluctuations of the fifth embodiment of the present invention;

FIG. 10 is a schematic cross sectional view of FIG. 9 along a B-B plane;

FIG. 11 is a schematic cross sectional view of the trapezoidal horizontal convex structure of the embodiments of the present invention;

FIG. 12 is a schematic cross sectional view of the horizontal convex structure with a mixed shape of rectangle and trapezoid of the embodiments of the present invention;

FIG. 13 is a schematic cross sectional view of the single-row trapezoidal vertical convex structure of the embodiments of the present invention;

FIG. 14 is a schematic cross sectional view of the single-row vertical convex structure with a mixed shape of rectangle and trapezoid of the embodiments of the present invention;

FIG. 15 is a schematic cross sectional view of the dual-row trapezoidal vertical convex structure of the embodiments of the present invention; and

FIG. 16 is a schematic cross sectional view of the dual-row vertical convex structure with a mixed shape of rectangle and trapezoid of the embodiments of the present invention.

### DETAILED DESCRIPTION OF THE PREFERRED EMBODIMENT

The accompanying drawings are included to provide a further understanding of the invention, and are incorporated in and constitute a part of this specification. The drawings illustrate embodiments of the invention and, together with the description, serve to explain the principles of the invention.

### First Embodiment

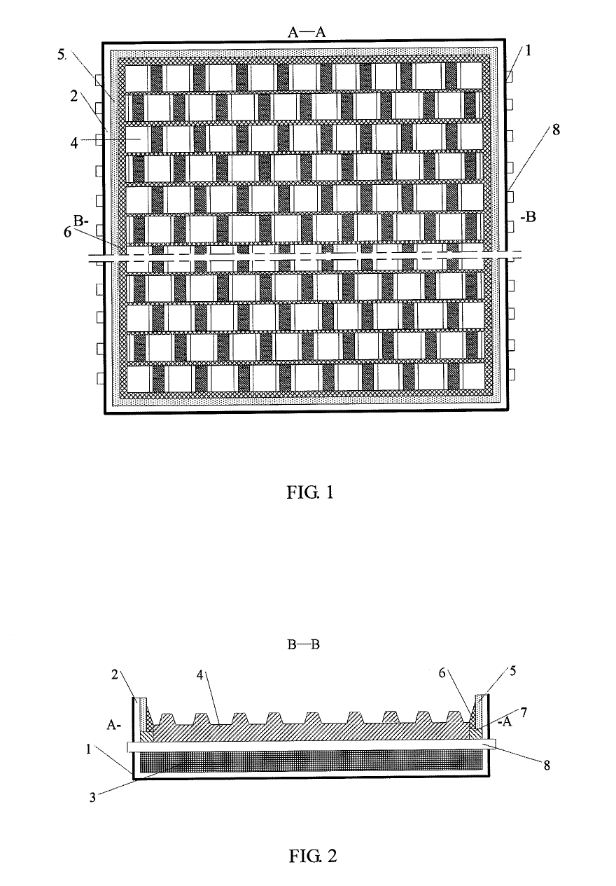

As shown in FIG. 1 and FIG. 2, the present invention provides an aluminum electrolytic cell with a new type of cathode structure for shortening vertical fluctuations and horizontal fluctuations. The exterior of the aluminum electrolytic cell is installed with a steel-made electrolytic cell shell 1, heat insulating material 2 equipped to the electrolytic cell shell 1 are asbestos plates, bottom refractor bricks and heat insulating bricks 3 are installed on the bottom asbestos plate of the heat insulating material 2, cathode carbon blocks 4 having convex structures and cathode steel bars 8 are installed on the top surface of the bottom refractory bricks and heat insulating bricks 3.

The inner lateral sides of the electrolytic cell are provided with lined carbon bricks 5. The cathode at the cell bottom of the electrolytic cell is configured by at least eight cathode carbon blocks 4 having convex structures and being installed cathode steel bars 8 at the bottoms. Each cathode carbon block 4 is horizontally disposed in the electrolytic cell, in other words the length direction of the cathode carbon block 4 is perpendicular to the length direction of the electrolytic cell. A 2040 mm gap is formed between the adjacent cathode carbon blocks 4, and the gap is tamped with carbon ramming paste 6. Refractory concrete 7 is used for tamping under the lined carbon bricks 5 and above the bottom refractor bricks and heat insulating bricks 3. The carbon ramming paste 6 is used for tamping between the lined carbon bricks 5 and the cathode carbon blocks 4. The bottoms of the cathode carbon blocks 4 are respectively installed with cells for accommodating the cathode steel bars 8, and two ends of each cathode steel bar 8 are protruded outside the cell shell 1 for serving as the cathode of the electrolytic cell.

The convex structures of each cathode carbon block in the aluminum electrolytic cell with convex structures are horizontal convex structures. The distance between the adjacent horizontal convex structures on a same cathode carbon block is 300˜500 mm; the horizontal convex structures on two adjacent cathode blocks are staggered with each other.

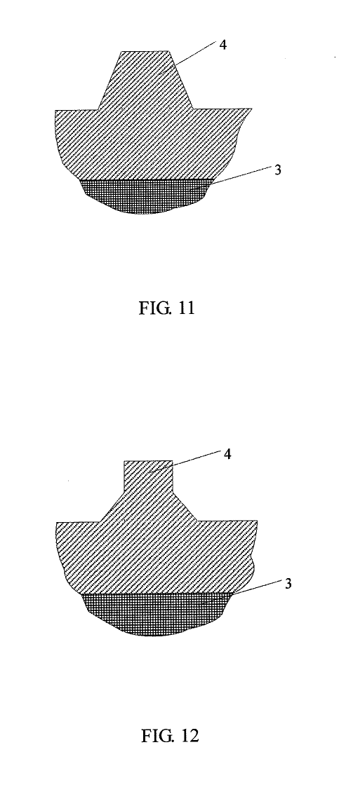

FIG. 11 shows the cross sectional view of the horizontal convex structure of the cathode carbon block 4. The cross section of the horizontal convex structure is in a trapezoidal shape, the width of the top surface is 150˜250 mm, the width of the lower portion connected to the carbon block base is 200˜300 mm, and the length is the same as the width of the cathode carbon block base.

Wherein on the cathode carbon block closest to an aluminum outlet, the aluminum outlet directly faces the gap defined by two horizontal convex structures.

The manufacturing method of cathode carbon block having convex structures is: the conventional material for manufacturing cathode carbon block is adopted, and a blank material is formed with a means of vibration molding, then is baked; or an elongated blank material is firstly manufactured with the means of vibration molding then is baked, and the required shape is formed through mechanical processing.

The aluminum electrolytic cell with a new type of cathode structure for shortening vertical fluctuations and horizontal fluctuations of this invention is processed with a baking operation of baking with flames or firstly baking with flames then baking aluminum fluid. After the baking operation, the electrolytic cell is started-up with a conventional means of electrolytic cell start-up.

In the normal production technology management after the electrolytic cell is started-up, the aluminum level in the electrolytic cell is 10˜50 mm after the aluminum is outputted and calculated from the top surface of convex structure. In the normal production, the ACD is 25˜40 mm, the cell voltage is 3.3˜3.9 V.

An alumina electrolyte sludge groove disposed on top of the carbon ramming paste and between two cathode carbon block bases at the bottom of the aluminum electrolytic cell is filled with alumina, in which a part thereof is powder, and cryolite powder. At the electrolysis temperature, the cryolite is molten so as to seal cracks or slits of the paste disposed at the cell bottom, such that the molten aluminum is prevented from leaking from the cracks and slits and from penetrating to the cell bottom. As such, the cathode steel bars are protected from being molten and the electrolytic cell is protected from being damaged. Beside the mentioned two points, in the normal production, arts adopted in the aluminum electrolytic cell with a new type of cathode structure for shortening vertical fluctuations and horizontal fluctuations of this invention are the same as the arts adopted in conventional aluminum electrolytic cell with cathode structures. The technical working conditions of the arts are as follows. The electrolyte level is 15˜25 cm, the molar ratio of electrolyte is 2.0˜2.8, the concentration of alumina is 1.5˜5%, and the electrolyte temperature is 935˜975° C.

After being tested, when the aluminum electrolytic cell with a new type of cathode structure for shortening vertical fluctuations and horizontal fluctuations of the present invention is operated, the aluminum level surface is stable, the power consumption is low, and the service life is obviously prolonged.

### Second Embodiment

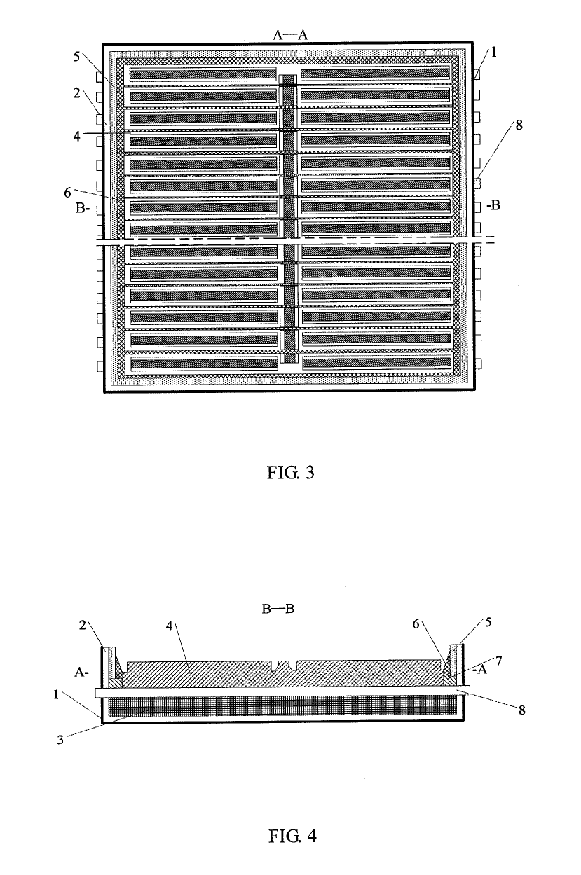

The aluminum electrolytic cell with a new type of cathode structure for shortening vertical fluctuations and horizontal fluctuations of this invention is shown in FIG. 3 and FIG. 4. The whole structure of the electrolytic cell is the same as the electrolytic cell disclosed in the first embodiment; the difference is that convex structures on the cathode carbon blocks are mixedly arranged with horizontal convex structures and vertical convex structures. The horizontal convex structure and vertical convex structures on each cathode carbon block base are staggered with each other. The quantity of horizontal convex structure is one, the length of the horizontal convex structure is the same as the width of the cathode carbon block base. The length of vertical convex structure is defined with respect to two vertical convex structures aligned on each cathode carbon block base. On a cathode carbon block, the distance between two ends of the cathode carbon block and the bottoms of the vertical convex structures arranged at the two ends is 30˜50 m. On the same cathode carbon block, the distance between the adjacent horizontal convex structure and the vertical convex structure is 30˜100 mm.

FIG. 12 shows the cross sectional view of the horizontal convex structure of the cathode carbon block 4. FIG. 14 shows the cross sectional view of the vertical convex structure. The cross section of the convex structure is in a mixed shape of rectangle and trapezoid, the width of the top surface of each convex structure is 150˜250 mm, the width of the lower portion connected to the cathode carbon block base is 200˜300 mm, the height of the convex structure is 80˜160 mm, the height of the trapezoid at the lower portion is at least one third of the total height of the convex structure.

On the cathode carbon block closest to the aluminum outlet, the minimum distance between the horizontal convex structure, near the aluminum outlet and disposed in the center of the cathode carbon block, and the outer lateral surface of the cathode carbon block base is 200˜300 mm; wherein the outer lateral surface of the cathode carbon block base is defined as the lateral surface of the cathode carbon block that faces the cell lining of the aluminum outlet.

An alumina electrolyte sludge groove is installed on top of carbon ramming paste 6 installed between the adjacent cathode carbon block bases, the depth of the sludge groove is 30˜60 mm, the width thereof is 80˜120 mm, the length thereof penetrates through the gap defined between the adjacent cathode carbon blocks. During the electrolytic production, the alumina electrolyte is filled in the sludge groove.

The operation method of the aluminum electrolytic cell with a new type of cathode structure for shortening vertical fluctuations and horizontal fluctuations is the same as the operation method disclosed in the first embodiment.

### Third Embodiment

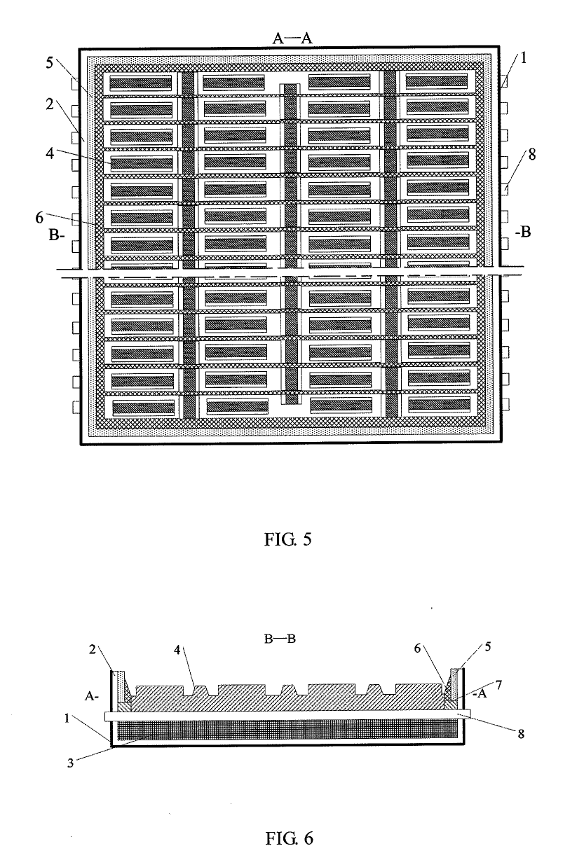

The aluminum electrolytic cell with a new type of cathode structure for shortening vertical fluctuations and horizontal fluctuations of this invention is shown in FIG. 5 and FIG. 6. The whole structure of the electrolytic cell is the same as the electrolytic cell disclosed in the first embodiment, the difference is that convex structures are mixedly arranged. Horizontal convex structures and vertical convex structures are staggered on each cathode carbon block base. The quantity of horizontal convex structure is three, the length thereof is the same as the width of the cathode carbon block base. The length of vertical convex structure is defined with respect to four vertical convex structures aligned on each cathode carbon block base. On a cathode carbon block, the distance between two ends of the cathode carbon block and the bottoms of the vertical convex structures arranged at the two ends is 30˜50 mm. Wherein on the same cathode carbon block, the distance between the adjacent convex structures is 30˜400 mm.

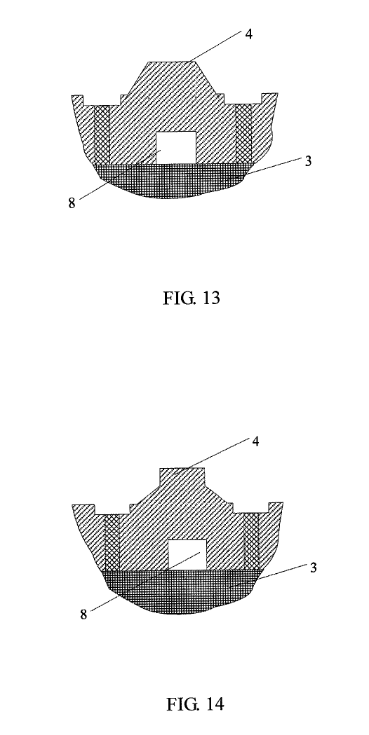

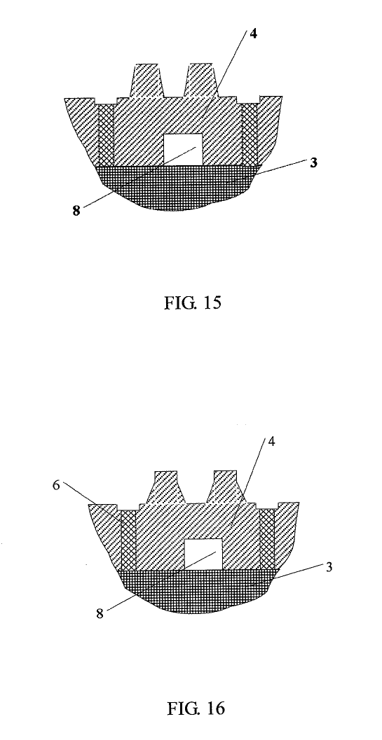

FIG. 13 shows the cross sectional view of the vertical convex structure of the cathode carbon block 4. FIG. 11 shows the cross sectional view of the horizontal convex structure. The cross section of the convex structure is in a trapezoidal shape, the width of top surface of each convex structure is 150˜250 mm, the width of the lower portion connected to the cathode carbon block base is 200˜300 mm, the height of the convex structure is 80˜160 mm. The width of the top surface of the horizontal convex structure disposed at the center of the cathode carbon block is 150˜200 mm.

On the cathode carbon block closest to the aluminum outlet, the minimum distance between the horizontal convex structure, near the aluminum outlet and disposed in the center of the cathode carbon block, and the outer lateral surface of the cathode carbon block base is 200˜300 mm; wherein the outer lateral surface of the cathode carbon block base is defined as the lateral surface of the cathode carbon block that faces the cell lining of the aluminum outlet.

An alumina electrolyte sludge groove is installed on top of carbon ramming paste 6 installed between the adjacent cathode carbon block bases, the depth of the sludge groove is 30˜60 mm, the width thereof is 80˜120 mm, the length thereof penetrates through the gap defined between the adjacent cathode carbon blocks. During the electrolytic production, the alumina electrolyte is filled in the sludge groove.

The operation method of the aluminum electrolytic cell with a new type of cathode structure for shortening vertical fluctuations and horizontal fluctuations is the same as the operation method disclosed in the first embodiment.

### Fourth Embodiment

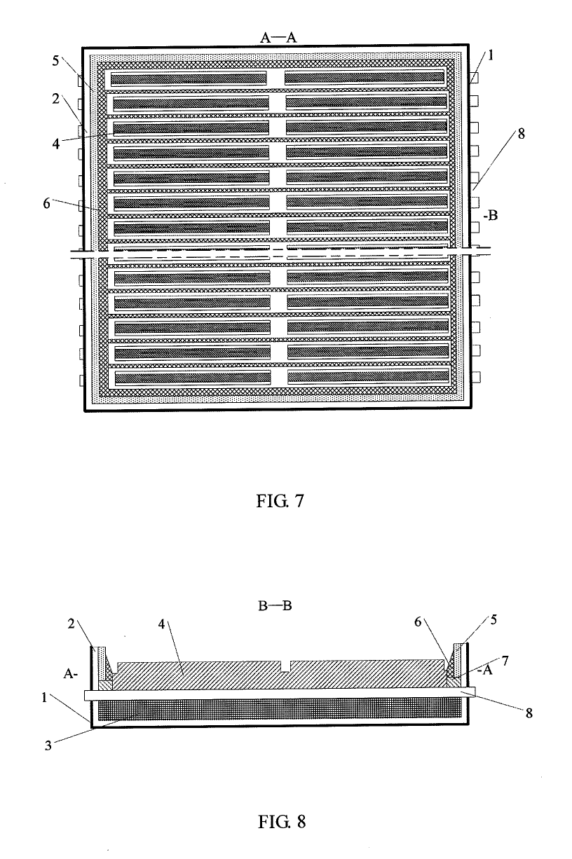

The aluminum electrolytic cell with a new type of cathode structure for shortening vertical fluctuations and horizontal fluctuations of this invention is shown in FIG. 7 and FIG. 8. The whole structure of the electrolytic cell is the same as the electrolytic cell disclosed in the first embodiment, the difference is that convex structures are vertical convex structures, and the vertical convex structures are installed at the center of the top surface of the cathode carbon block base. The quantity of vertical convex structures is two. The distance between two ends of the cathode carbon block and the bottoms of the vertical convex structures arranged at the two ends is 30˜50m. On the same cathode carbon block, the distance between the adjacent vertical convex structures is 100˜200 mm.

FIG. 14 shows the cross sectional view of the vertical convex structure. The cross section of the convex structure is in a mixed shape of rectangle and trapezoid, the width of the top surface of convex structure is 150˜250 mm, the width of the lower portion connected to the cathode carbon block base is 200˜300 mm, the height of the convex structure is 80˜160 mm, the height of the trapezoid at the lower portion is at least one third of the total height of the convex structure.

The vertical convex structures are disposed at two ends with respect to the center of the cathode carbon block base. The gap defined between the two vertical convex structures directly faces the aluminum outlet.

An alumina electrolyte sludge groove is installed on top of carbon ramming paste 6 installed between the adjacent cathode carbon block bases, the depth of the sludge groove is 30˜60 mm, the width thereof is 80˜120 mm, the length thereof penetrates through the gap defined between the adjacent cathode carbon blocks. During the electrolytic production, the alumina electrolyte is filled in the sludge groove.

The operation method of the aluminum electrolytic cell with a new type of cathode structure for shortening vertical fluctuations and horizontal fluctuations is the same as the operation method disclosed in the first embodiment.

### Fifth Embodiment

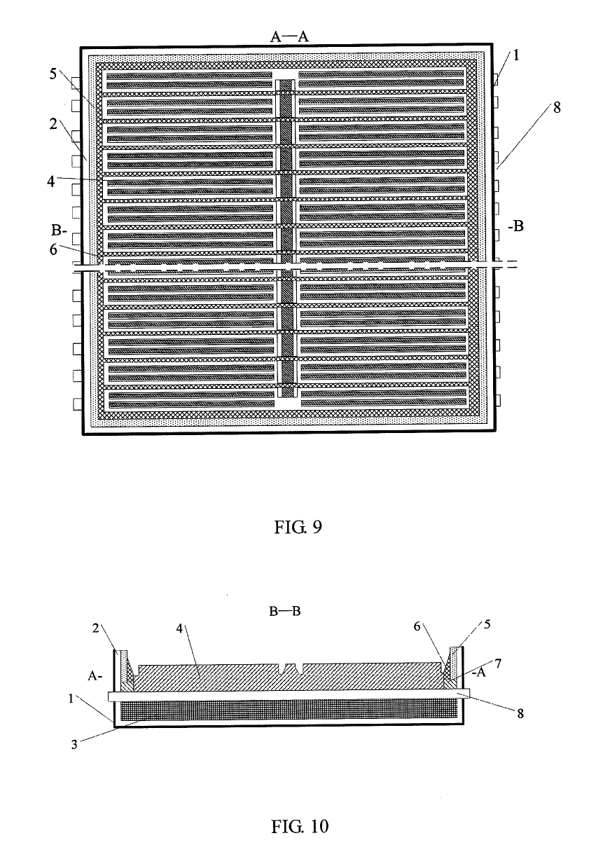

The aluminum electrolytic cell with a new type of cathode structure for shortening vertical fluctuations and horizontal fluctuations of this invention is shown in FIG. 9 and FIG. 10. The whole structure of the electrolytic cell is the same as the electrolytic cell disclosed in the first embodiment, the difference is that convex structures are mixedly arranged, wherein the quantity of horizontal convex structure is one, the length thereof is the same as the width of the cathode carbon block base. The length of vertical convex structure is defined with respect to four vertical convex structures arranged as two rows on each cathode carbon block. Every two vertical convex structures arranged at the same row is defined as one set, thus there are two defined sets of vertical convex structure, and each set of vertical convex structure is staggered with one horizontal convex structure.

There are five convex structures installed on each cathode carbon block base. The distance between two ends of the cathode carbon blocks and the bottoms of the vertical convex structures arranged at the two ends is 30˜50 mm. The distance between the horizontal convex structure and each set of vertical convex structure is 30˜100 mm.

The convex structure at the center of the cathode carbon block is the horizontal convex structure. The minimum distance between the horizontal convex structure, near the aluminum outlet and disposed in the center of the cathode carbon block, and the outer lateral surface of the cathode carbon block base is 200˜300 mm; wherein the outer lateral surface of the cathode carbon block base is defined as the lateral surface of the cathode carbon block that faces the cell lining of the aluminum outlet.

FIG. 16 shows the cross sectional view of the vertical convex structure of the cathode carbon block. FIG. 12 shows the cross sectional view of the horizontal convex structure. The cross section of the convex structure is in a mixed shape of rectangle and trapezoid, the width of top surface of the vertical convex structure is 80˜120 mm, the width of top surface of the horizontal convex structure is 150˜200 mm, the height of the vertical and horizontal convex structures is 80˜160 mm, the distance between each set of vertical convex structure is 30˜100 mm, the height of the trapezoidal at the lower portion is at least one third of the total height of the convex structure.

The operation method of the aluminum electrolytic cell with a new type of cathode structure for shortening vertical fluctuations and horizontal fluctuations is the same as the operation method disclosed in the first embodiment.

Although the present invention has been described with reference to the preferred embodiments thereof, it is apparent to those skilled in the art that a variety of modifications and changes may be made without departing from the scope of the present invention which is intended to be defined by the appended claims.

What is claimed is:

1. An aluminum electrolytic cell with a new type of cathode structure for shortening vertical fluctuations and horizontal fluctuations includes: an electrolytic cell shell, cell lining, refractory material, cathode carbon blocks, lined carbon bricks, carbon ramming paste, refractory concrete and cathode steel bars, and characterized in that more than one convex structure protrudes from the top surface of the cathode carbon blocks and integrates with the cathode carbon blocks, the convex structures are arrayed to be parallel or vertical to the axis of the cathode carbon blocks or to be mixed with the above two, wherein the convex structure vertical to the axis of the cathode carbon blocks is defined as a horizontal convex structure, the convex structure parallel to the axis of the cathode carbon blocks is defined as a vertical convex structure.

2. The aluminum electrolytic cell according to claim 1, wherein the cross section of the convex structure is in a rectangular or trapezoidal shape or in a mixed shape of rectangle and trapezoid; when the cross section is in the mixed shape of rectangle and trapezoid, the rectangle is above the trapezoid.

3. The aluminum electrolytic cell according to claim 1, wherein the width of the cross section of the convex structures on the cathode carbon blocks is set with respect to the width of the cathode carbon block base; in a state that the width of the cathode carbon block base is 400 mm, the width of the upper portion of the cross section of the horizontal convex structure is 150˜250 mm, the width of the lower portion thereof is 200˜300 mm; the vertical convex structures are arranged as a single-row arrangement or a dual-row arrangement, when being arranged as the single-row arrangement, the width of the upper portion of the cross section of the vertical convex structure is 150˜250 mm, the width of the lower portion thereof is 200˜300 mm; when being arranged as the dual-row arrangement, the width of the upper portion of the cross section of the vertical convex structure is 80˜120 mm, the height of the cross section of the vertical convex structure is 80˜160 mm; when the width of the cathode carbon block base is increased, the size of the cross section of the convex structure is proportionally enlarged.

4. The aluminum electrolytic cell according to claim 1, wherein when the convex structures on the cathode carbon blocks are all horizontal convex structures, each horizontal convex structure on two adjacent cathode carbon blocks are staggered with each other; the length of the horizontal convex structure is the same or 40˜60 mm smaller than the width of the cathode carbon block base; the minimum distance between the adjacent horizontal convex structures on a same cathode carbon block is 300˜500 mm; the center location of the cathode carbon block closest to an aluminum outlet is a gap defined by two horizontal convex structures.

5. The aluminum electrolytic cell according to claim 1, wherein when the convex structures on the cathode carbon blocks are all vertical convex structures, the axis of each vertical convex structure is parallel to the axis of the cathode carbon block base, the length thereof is defined with respect to at least two vertical convex structures aligned on each cathode carbon block, the distance between two ends of the cathode carbon block and the bottoms of the vertical convex structures arranged at the two ends is 30˜50 mm; the vertical convex structures are arranged at two ends with respect to the center of the cathode carbon block base, the gap defined by two vertical convex structures arranged at the middle directly faces the aluminum outlet, the minimum distance between the adjacent vertical convex structures on a same cathode carbon block is 100˜200 mm.

6. The aluminum electrolytic cell according to claim 1, wherein, when the convex structures of the cathode carbon blocks are mixedly arranged, the heights of the horizontal convex structures and the vertical convex structures are the same, the distance between the horizontal convex structure and the vertical convex structure is 30˜100 mm; the convex structure at the center of the cathode carbon block base is the horizontal convex structure; on the cathode carbon block closest to the aluminum outlet, the minimum distance between the horizontal convex structure near the aluminum outlet and the outer lateral surface of the cathode carbon block base is 200˜300 mm; the outer lateral surface of the cathode carbon block base is defined as the lateral surface of the cathode carbon block that faces the cell lining of the aluminum outlet; the mixed arrangements of the horizontal convex structures and the vertical convex structures are categorized to a discontinuous arrangement and a continuous arrangement, when being arranged as the discontinuous arrangement, the distance between the horizontal convex structure and the vertical convex structure is 30˜100 mm; when being arranged as the continuous arrangement, the horizontal convex structure is connected with the vertical convex structure.

7. The aluminum electrolytic cell according to claim 1, wherein when the convex structures of the cathode carbon block are mixedly arranged, the arrangements of the vertical convex structures can be categorized to a single-row arrangement and a dual-row arrangement, when being arranged as the single-row arrangement, the vertical convex structures and the horizontal convex structures on each cathode carbon block are staggered with each other; when being arranged as the dual-row arrangement, the convex structure of each cathode carbon block is four vertical convex structures and one horizontal convex structure, every two vertical convex structures aligned as two rows on each cathode carbon block is defined as one set, every two sets of vertical convex structure is staggered with the horizontal convex structure disposed at the center of the cathode carbon block, the minimum distance between a set of vertical convex structure is 30˜100 mm; wherein the mixed arrangements of the horizontal convex structures and the vertical structures are categorized to a discontinuous arrangement and a continuous arrangement, when being arranged as the discontinuous arrangement, the distance between the horizontal convex structure and the vertical convex structure is 30˜400 mm; when being arranged with as the continuous arrangement, the horizontal convex structure is connected with the vertical convex structure.

8. The aluminum electrolytic cell according to claim 1, wherein lateral sides of the interior of the electrolytic cell shell are installed with lined carbon bricks, the cathode at the cell bottom of the electrolytic cell is configured by at least eight cathode carbon blocks having convex structures; a 20˜40 mm gap is formed between the adjacent cathode carbon blocks, and the gap is tamped with the carbon ramming paste; the refractory concrete is used for tamping under the lined carbon bricks and above the bottom refractor bricks and heat insulating bricks; the carbon ramming paste is used for tamping between the lined carbon bricks and the cathode carbon blocks; the bottoms of the cathode carbon blocks are connected with the cathode steel bars, and two ends of each cathode steel bar are protruded outside the electrolytic cell shell for serving as the cathode of the electrolytic cell; a sludge groove is installed between two adjacent cathode carbon blocks, the installation method of sludge groove is: two lateral sides of the top surface of the cathode carbon block base are installed with angular grooves, and a concave sludge groove is defined between two opposite angular grooves respectively on two adjacent cathode carbon blocks and the top surface of carbon ramming paste; in the electrolytic production, the sludge groove is filled with a sludge made of cryolite and alumina for preventing the cathode steel bars from being molten by the molten aluminum; the depth of the angular groove is 20˜50 mm with respect to the top surface of the cathode carbon block base, the width thereof is 20˜50 mm, the length thereof is the same as the length of the cathode carbon block; the depth of the sludge groove is 20˜50 mm, and the width thereof is 80˜140 mm.

9. The aluminum electrolytic cell according to claim 1, wherein in the normal production of the aluminum electrolytic cell with a new type of cathode structure for shortening vertical fluctuations and horizontal fluctuations, all of the convex structures on the cathode surfaces in the electrolytic cell are immerged in the molten aluminum, an electrolyte molten member is formed above the molten aluminum, the aluminum level in the electrolytic cell is 10˜50 mm after the aluminum is outputted and calculated from the top surface of convex structure; the working voltage of the electrolytic cell is 3.3˜3.9 V.

10. The aluminum electrolytic cell according to claim 1, wherein the manufacturing method of the aluminum electrolytic cell comprises the following steps: the conventional material for manufacturing cathode carbon blocks is adopted, and a blank material is formed with a means of vibration molding, then is baked; or an elongated blank material is firstly manufactured with the means of vibration molding then is baked, and the required shape is formed through mechanical processing.
